(19) United States
(12) Patent Application Publication
(10) Pub. No.: US 2010/0288068 A1
(43) Pub. Date: Nov. 18, 2010

(54) STEERING ARRANGEMENT FOR A MOTOR VEHICLE HAVING A ROTATABLE STEERING HANDLE

(76) Inventor: Christoph KLUKOWSKI, Gamprin (LI)

Correspondence Address: WENDEROTH, LIND & PONACK, L.L.P., 1030 15th Street, N.W.,, Suite 400 East, Washington, DC, 20005-1503, US

(21) Appl. No.: 12/841,537

(22) Filed: Jul. 22, 2010

Related U.S. Application Data
(63) Continuation of application No. PCT/EP2009/000136, filed on Jan. 13, 2009.

(30) Foreign Application Priority Data
Jan. 23, 2008 (DE) 10 2008 005 793.2

(51) Int. Cl. B62D 1/16; B62D 1/02

(52) U.S. Cl. 74/492

(57) ABSTRACT

The invention relates to a steering arrangement for a vehicle and has a rotatable steering handle, particularly a steering wheel, and a steering shaft rotationally connected thereto. At least one generator unit is provided for generating at least one haptic signal, wherein the steering shaft is supported in a casing unit of the steering arrangement, and the casing unit is connected to the generator unit for generating at least one haptic signal and is disposed as a transmission unit for transmitting the haptic signal to be generated by the generator unit to the steering shaft between the generator unit and the steering shaft.

This application is a continuation application of International application PCT/EP2009/000136, filed Jan. 13, 2009, the entire disclosure of which is incorporated herein by reference.

### BACKGROUND OF THE INVENTION

a) Field of the Invention

The invention relates to a steering arrangement for a motor vehicle with a rotatable steering handle, in particular a steering wheel, and a steering spindle connected torsion-tight therewith and at least one generator device for at least one haptic signal.

b) Description of Related Prior Art

The fundamental purpose of the steering arrangement known per se with a generator device for at least one haptic signal is conveying a signal, in particular a warning signal, to the driver of the motor vehicle via the tactile sense in his hands. It is in principle conceivable to integrate the generator device directly into the steering handle of the steering wheel. However, since a steering wheel must always be suspended such that it is rotatable, problems are encountered regarding the signal transmission onto the steering wheel. While this can be solved by using contact rings or twisted wires or the like, it is however always relatively complex.

Another approach for transmitting haptic signals onto a steering wheel is disclosed in DE 10 2004 062 820 A1. In this publication, a rechargeable mechanical energy store, for example in the form of a torsionable elastic body, is proposed, which, by means of frictional closure, acts, optionally via a reversing wheel or directly, onto the steering spindle connected with the steering wheel. While hereby the necessity of the signal transmission by means of contact rings or twisted wires onto the steering wheel is avoided, there is nevertheless a relatively complex additional part necessary in order to be able to transmit the haptic signals onto the steering wheel. It appears moreover questionable whether or not the transmission by means of frictional closure proposed in this publication operates reliably over the long term.

### SUMMARY OF THE INVENTION

The problem addressed by the invention is proposing an alternative solution regarding the manner in which, at as simple a construction as is possible, a haptic signal can be transmitted in a generic steering arrangement onto a steering handle or steering wheel.

The solution proposed for this purpose is that the steering spindle is supported in a jacket unit of the steering arrangement. The jacket unit is connected with the generator device for at least one haptic signal, and when used as a transmission device for the transmission of the haptic signal, generatable by the generator device, onto the steering spindle, the jacket unit is located between the generator device and the steering spindle.

Consequently, a fundamental idea of the present invention is utilizing the jacket unit, in which the steering spindle is bearing supported, in addition to its bearing function, as a transmission device for the transmission of the haptic signal generated by the generator device onto the steering spindle. The jacket unit herein advantageously assumes the function of a resonance box via which haptic signals, thus signals perceptible through the tactile sense, can be transmitted onto the steering spindle and thus also onto the steering wheel or a differently developed steering handle. For this purpose, the jacket unit forming the resonance box preferably has a resonance frequency agreeing with a frequency of the haptic signal generatable by the generator device or is at least so close to the frequency of the haptic signal that the jacket unit can be set into resonance. In principle, these haptic signals can be oscillations or vibrations as well as also directed mechanical forces or torques. The steering wheel or the steering handle is that structural part of the steering arrangement which is provided for the purpose of transmitting the steering movement onto the motor vehicle through manual actuation by the driver. The jacket unit can herein be in physical contact on the one hand with the steering spindle and, on the other hand, with the generation device for the at least one haptic signal such that the haptic signals generated by the generation device are transmitted via the jacket unit onto the steering spindle, and, such that they are perceptible by the tactile sense of the driver, onto the steering wheel or other steering handle.

In the embodiment of the invention, it is advantageously to be observed that, as a rule, an especially rigid implementation of the steering column is required. Therefore, the generator device for the haptic signal is advantageously not integrated into the securement of the steering column on the motor vehicle. The generator device for the at least one haptic signal is therefore advantageously disposed on the jacket unit.

However, it is also feasible for the generator device for the at least one haptic signal to be indirectly in connection, via at least one further structural part of the steering arrangement, with the jacket unit for the transmission of the haptic signal.

The jacket unit herein, as is known per se, assumes advantageously the bearing function for the steering spindle. In this context, it is thus preferably provided that the steering spindle in an installation position of the steering arrangement in the motor vehicle is borne by the jacket unit. The steering spindle is advantageously held by the jacket unit against the force of gravity in the motor vehicle. In order to realize such, it can be provided that the jacket unit encompasses in the form of a tunnel or tube at least regionally a hollow volume and that the steering spindle is guided through this hollow volume. For the bearing support of the steering spindle in the jacket unit at least one, and preferably at least two, bearing(s) can be disposed on the jacket unit. The steering spindle is bearing supported by the bearing or the bearings in the jacket unit. To secure the jacket unit on the motor vehicle, in turn, a so-called chassis-anchored console unit can be provided. This unit can be implemented for example as a securement means for fixing the jacket unit in a single predetermined position on the motor vehicle. However, it is more advantageous for the console unit to include an adjustment mechanism with which the jacket unit can be secured in positions differing from one another on the console unit and therewith in the motor vehicle. Such an adjustment mechanism can be utilized to adapt the position of the steering wheel to the particular driver of the motor vehicle. The adjustment mechanism for this purpose advantageously permits the adjustment of the position of the jacket unit in the longitudinal direction of the steering spindle and/or in the direction vertical with respect to an installation position of the steering arrangement in the motor vehicle. In terms of the indirect connection, already described above, of the jacket unit with the generator device via at least one further structural part of the steering arrangement, it can be provided in this context that the generator device for the at least one haptic signal is disposed on the adjustment mechanism and/or on the console unit. In principle, it is certainly conceivable to dispose not only one but rather two or more generator devices at several sites such that the haptic signals generated by them can be introduced via the jacket unit into the steering spindle.

The generator device is preferably disposed on a structural part which can be moved jointly with the jacket unit. It therefore becomes possible to implement the entire steering column and in particular the mounting stationary on the motor vehicle body very rigidly, as most often demanded, and simultaneously to make possible the insertion of sound. Such systems can also readily be adapted as a retrofit assembly or as an optional variant into the steering system.

As a generator device for the at least one haptic signal, vibrators or other generators of mechanical vibrations or pinging signals can be considered. However, it is also conceivable to utilize mechanical sources for the generation of directed signals and to feed these signals subsequently via the jacket unit into the steering spindle. For the generation of vibrations or mechanical oscillations, the generator device for the at least one haptic signal can comprise a piezoelectric oscillator or a magnetic coil arrangement or a, preferably electric, motor for moving, preferably for rotating, an unbalanced mass or an eccentric. Such generator devices for oscillations are known per se in prior art and are here only explained by example in different embodiments.

It is advantageously provided that the steering arrangement includes a regulation device for activating the generator device for the at least one haptic signal as a function of a parameter of the state of the motor vehicle.

The generator device for the at least one haptic signal is advantageously suitable for generating suitable, preferably as a function of an activation through a regulation device, at least two, preferably several, different haptic signals differing from the inactive state of the generator device. Preferably, the differing haptic signals differ from one another in terms of amplitude and/or frequency and/or duration.

Further details and features of preferred embodiments of the invention are evident based on the following description of the Figures.

### BRIEF DESCRIPTION OF THE DRAWING

In the drawings:

FIG. 1 is a schematic diagram to explain the invention,

FIGS. 2 to 7 show several embodiments of the manner in which the generator device for the at least one haptic signal can be connected with a jacket unit, and

FIGS. 8 to 11 show several examples of generator devices.

### DETAILED DESCRIPTION OF THE PREFERRED EMBODIMENTS

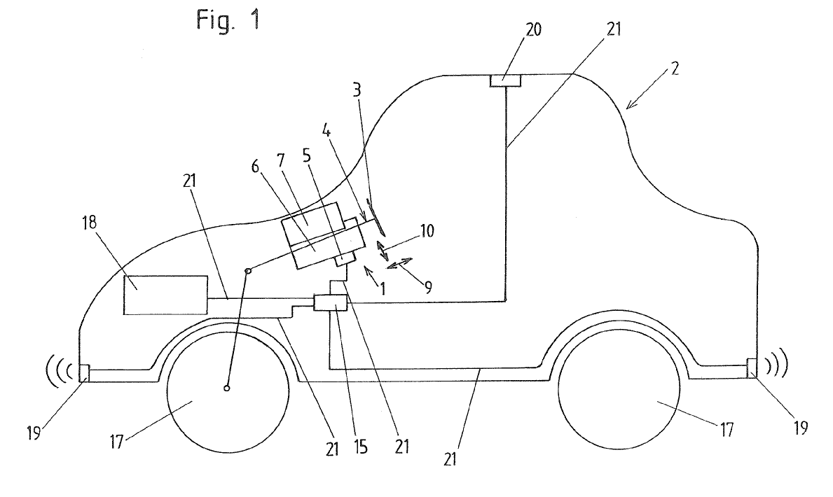

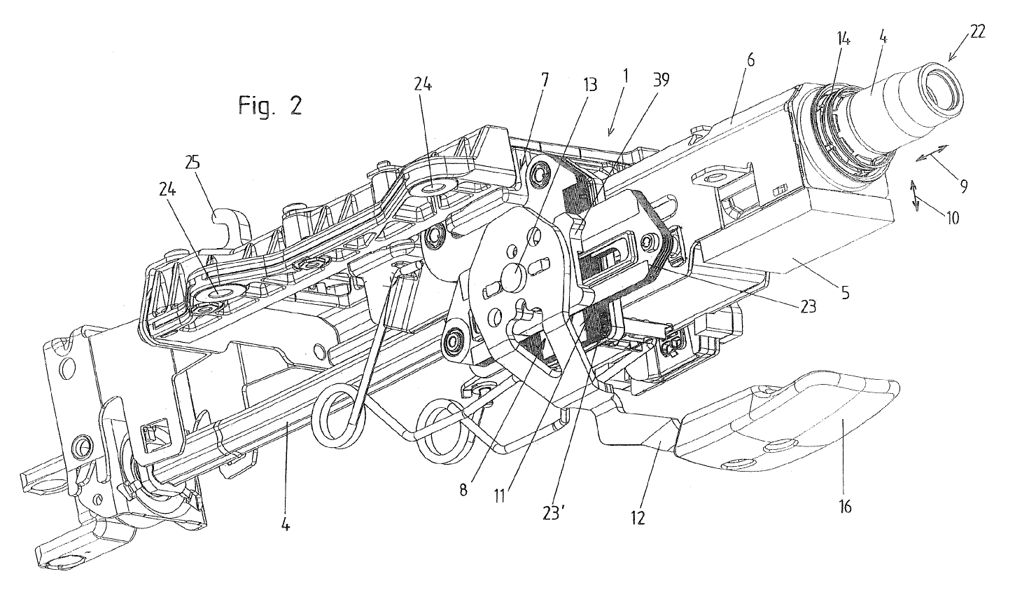

FIG. 1, firstly, shows (highly schematically) the disposition of a steering arrangement 1 in a motor vehicle 2. The steering arrangement 1 includes herein a steering wheel 3 connected torsion-tight with a steering spindle 4. The steering spindle 4, in turn, is rotatably bearing supported in a jacket unit 6. For the securement of the jacket unit 6 a console unit 7 is provided, which, for example, can be secured by bolting or welding or other securing measures on the motor vehicle body or a frame of the motor vehicle. The transmission of the rotational movement of the steering spindle 4 onto the front wheels 17 takes place as is known in the prior art and is not shown here in detail. To be able to adapt the position of the steering wheel 3 to the driver, an adjustment mechanism 8 is provided (not shown in FIG. 1, however, depicted in the embodiments of FIGS. 2 to 5). This mechanism permits securing the jacket unit 6 in several positions on the console unit 7. It is herein advantageous to implement the adjustment mechanism 8 such that the steering wheel 3 is adjustable in the longitudinal direction 9 of the steering spindle and/or in the vertical direction 10 with respect to the depicted installation position.

In the variant depicted schematically in FIG. 1, the generation device 5 for the haptic signal is disposed directly on the jacket unit 6, as shown in FIG. 2. The generator device 5 is connected with the regulation device 15 across a signal line 21. In the depicted embodiment example, the regulation device 15 receives across the corresponding signal lines 21 several parameters of the state of the motor vehicle in order to monitor these and, in the event of a discrepancy from predetermined nominal values, to generate a signal for activating the generator device 5. In this context are specifically shown on the front and the rear side of the motor vehicle 2 measuring devices for determining the distance and/or the relative speed of other motor vehicles or obstacles located in front or behind the motor vehicle 2. The motor vehicle 2 shown in FIG. 1 also includes a position determination sensor 20. This sensor can be a Global Positioning System GPS antenna, known per se, of a navigation system. The regulation device 15, furthermore, also receives across the corresponding signal line 21 parameters of the state of the internal combustion engine 18. The depicted sensors, however, are only examples. It is in principle conceivable to integrate into a steering arrangement in an embodiment according to the invention any monitoring mechanism known in the prior art for parameters of the state of the motor vehicle 2. The particular measured parameters are advantageously compared with nominal values or nominal value ranges. A discrepancy of the measured parameters from the nominal values can subsequently be analyzed by the regulation device 15 to the effect that the generator device 5 receives an activation signal across the signal line 21, whereupon the device transmits a haptic signal to the jacket unit 6 and therewith via the steering spindle 4 onto the steering wheel 3. In this manner, for example engine parameters, such as engine speed, oil pressure, temperature, different ignition parameters and the like, can be monitored and analyzed in order to generate a haptic signal in the event of malfunctions or other discrepancies from nominal values. It is understood that the same also applies to other motor vehicle parameters such as tire pressure, level of fill of the gas tank, state of closure of the doors and other hatches and lids of the motor vehicle, operatability of the illumination of the motor vehicle, etc. It is moreover also feasible to monitor via the sensors 19 distance and relative speed in order to generate a corresponding haptic signal in hazardous situations. Via the position determination sensor 20 and a corresponding regulation device 15, it is also feasible to track any possible discrepancies of the motor vehicle from the predetermined path. It can thus be provided that, in connection with a navigation system known per se, haptic signals are generated if the motor vehicle leaves the predetermined path. In the same manner it can also be prevented that, for example if due to the driver falling asleep, the motor vehicle leaves the trail or the road, corresponding haptic signals are generated when the trail is left. However, all of these, as stated, are only examples.

Advantageous embodiments provide that the generator device 5 for the at least one haptic signal is suitable, preferably as a function of activation by the regulation device, to generate at least two, preferably several, different haptic signals differing from the inactive state of the generator device. It is possible, for example, that the differing haptic signals differ from one another in amplitude and/or frequency and/or duration and/or direction. It is hereby feasible to adapt the type, the duration, the direction and/or the strength of the haptic signals to the particular hazardous situation. In the case in which the nominal value is minimally exceeded or fallen below, for example, a comparatively weak or short signal is generated which, with increasing hazard of the situation, is correspondingly amplified, extended or changed, thus in some form becomes more intensely perceptible to the user, thus becomes more insistent and frantic. It is also just as feasible to generate different haptic signals for several monitored parameters in order for the user to be able to detect, based on the type of haptic signal, which of the monitored parameters has a discrepancy from the nominal value or nominal value range.

FIG. 2 shows the upper portion, here relevant for the invention, of a steering arrangement 1 according to the invention. The steering spindle 4 is supported in the jacket unit 6 via the bearing 14. To secure a steering wheel 3, the connection piece 22 of the steering spindle 4 is provided. The jacket unit 6 is shaped in the form of a tunnel and the steering spindle 4 is guided through the inner hollow volume of this tunnel. To secure the jacket unit 6 on the motor vehicle 2, the console unit 7 is provided. In the embodiment depicted here, this jack unit is fixed in position on the motor vehicle 2 via securement holes 24 and a hook 25. In the depicted embodiment, an adjustment mechanism 8 is provided, by means of which the jacket unit 6 can be secured on the console unit 7 in different positions relative thereto. In the specifically implemented example this adjustment mechanism 8 includes a clamping mechanism 11. This mechanism in turn comprises, as is known per se, two disc packs 23 and 23′ one engaging into the other, wherein the disc pack 23 is fixed on the jacket unit 6 and the disc pack 23′ on the console unit 7. Via the connection bolt 13, both the disc packs 23 and 23′ are pressed against one another in an interlocking position so that the jacket unit 6 in this position is secured on the console unit 7. To change this position in the longitudinal direction 9 of the steering spindle 4 or in a (in the depicted mounting position vertical direction 10, the connection bolt 13 is brought by means of the manual operating lever 12 into the unlocking position, in which the disc packs 23 and 23′ are no longer pressed onto one another and the jacket unit 6 can be displaced relative to the console unit 7. To secure the newly set position in place, the manual operating lever 12, and therewith also the connection bolt 13, is brought again into the interlocking position depicted in FIG. 2, wherewith the jacket unit 6 is again secured relative to the console unit 7 thereon. This is known per se and does not need to be explained in detail. The adjustment mechanism 8 certainly does not absolutely need to include a clamping mechanism 11. Other types of adjusting and securing are also conceivable, for example by bolting, by spindle drives or the like. Adjustment variants between jacket unit 6 and console unit 7 operated by motor and optionally gearings can also be laid out according to the invention.

In the embodiment e according to FIG. 2, the generator device 5 for the generation of the haptic signal is disposed directly on the jacket unit 6 in contact on the outside. As soon as the generator device 5 generates a haptic signal, this is first transmitted to the jacket unit 6 and subsequently via the bearing 14 onto the steering spindle 4 and thereby also onto the steering wheel 3, not shown here. The signal lines 21 as well as also the regulation device 15 are not shown in FIGS. 2 to 5, however, the electrical circuitry can be realized as shown schematically in FIG. 1.

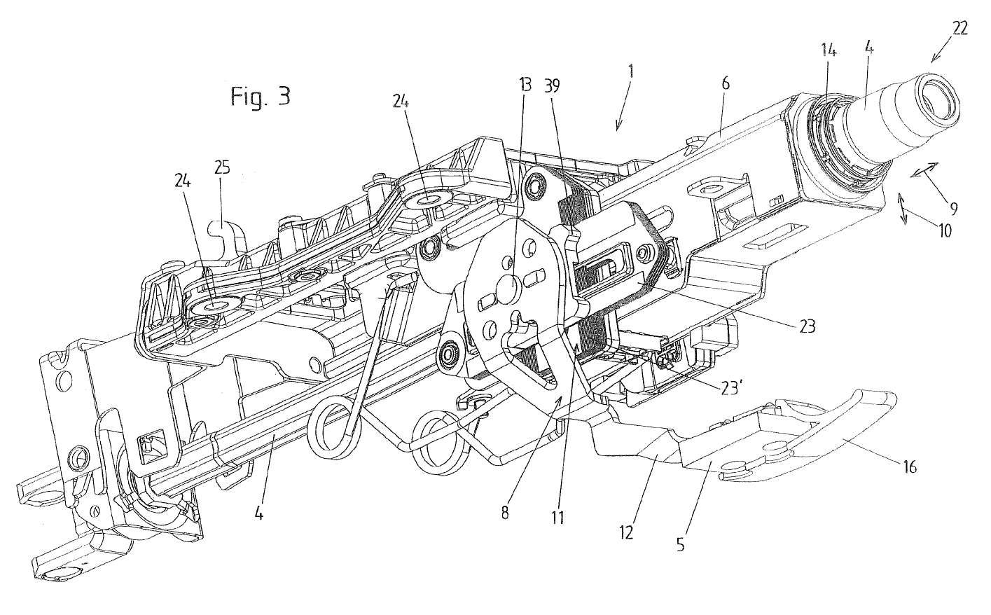

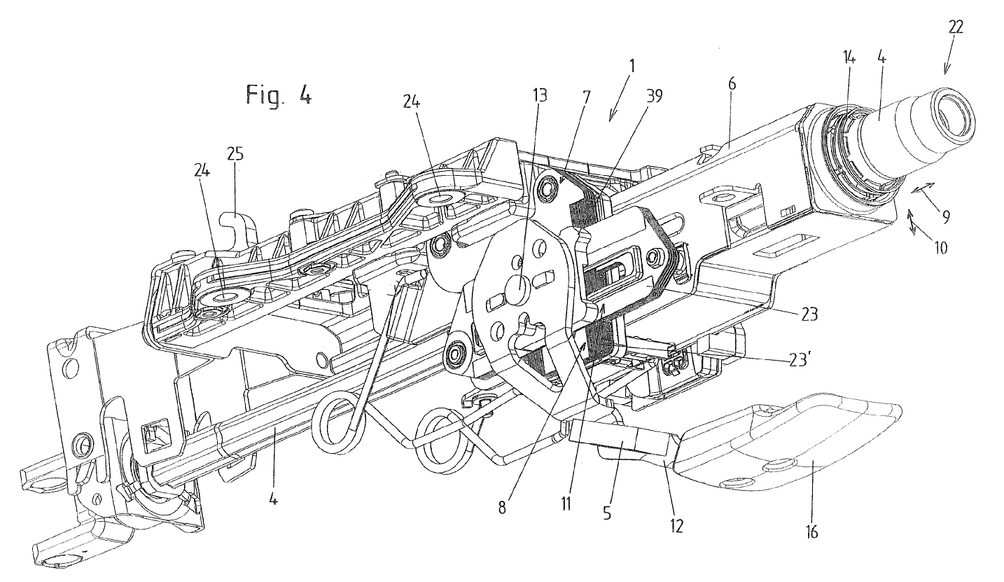

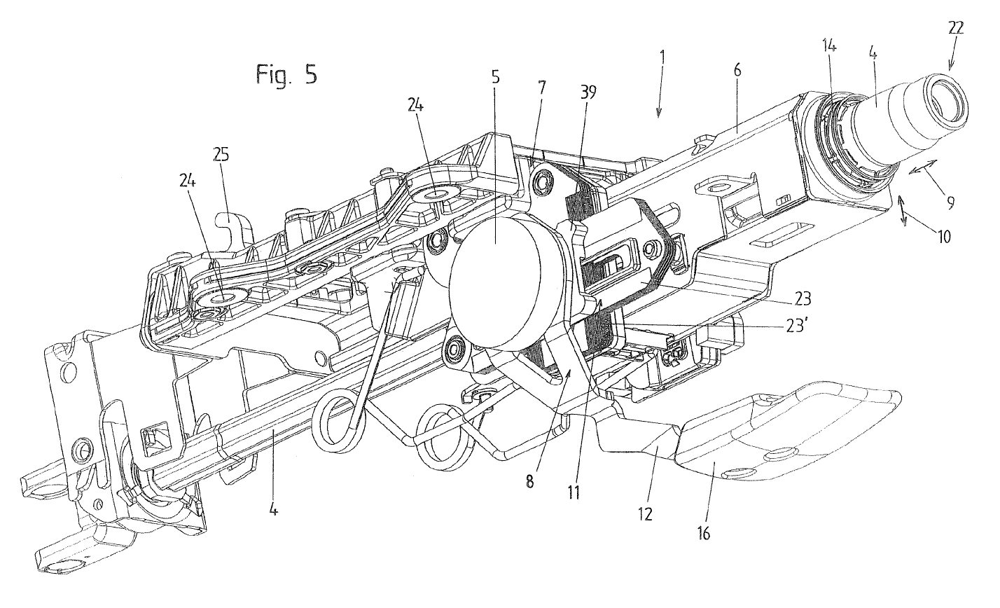

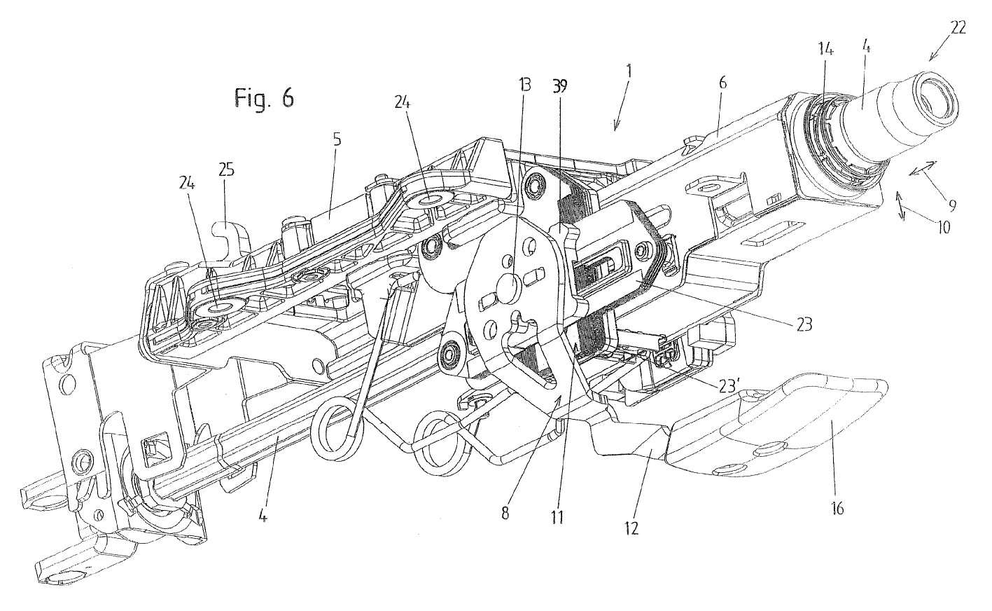

While the generator device 5 in the embodiment according to FIG. 2 is disposed directly on the jacket unit 6, in the embodiments according to FIGS. 3 and 4, it is indirectly in connection with the jacket unit 6. In the embodiment according to FIG. 3 as well as also in that according to FIG. 4, the generator device 5 is disposed on the manual operating lever 12 of the adjustment mechanism 8. In the variant according to FIG. 3, the generator device 5 is directly integrated into the grip part 16 of the manual operating lever 12 provided for actuation by hand. The haptic signal generated by the generator device 5 is therefore transmitted from the manual operating lever 12 via the interconnection of the interspaced elements, such as the connection bolt 13, the clamping plates 39, the disc packs 23, 23′ and the console unit 7, onto the jacket unit 6 and from here is conducted via the bearings 14 onto the steering spindle 4 and therewith to the steering wheel 3. Apart from the described differences, the embodiments according to FIGS. 3 and 4 are constructionally identical to the embodiment according to FIG. 2. This applies also to the embodiments according to FIGS. 5 and 6. In contrast to the previously described embodiments, the generator device 5 for the haptic signal in FIG. 5, however, is disposed directly on the connection bolt 13. The haptic signal generated by the generator device 5 of this embodiment example is consequently transmitted directly via the connection bolt 13 and/or indirectly via the already described interspaced elements onto the jacket unit 6 in order to be transferred further from this unit via the bearings 14 onto the steering spindle 4. FIG. 6 shows an example of the manner in which the generator device 5 for the at least one haptic signal can be disposed on the console unit 7 such that the haptic signal is transmittable onto the jacket unit 6.

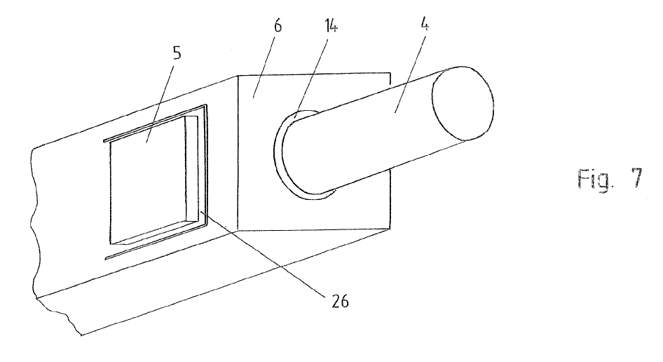

FIG. 7 shows schematically a variant in which the jacket unit 6 includes a tongue 26 which is set into vibration by the generator device 5 in order to be able to generate in this manner an especially explicitly perceptible haptic signal. In the depicted variant the generator device 5 is disposed directly on the tongue 26. However, this does not necessarily need to be the case. Of primary importance is that the tongue 26 is secured, on the one hand, on the jacket unit 6. On the other hand, the tongue 26 also comprises regions which can vibrate relative to the jacket unit. In the depicted example, the tongue 26 is formed by regional stamping out of the jacket unit 6. However, any other suitable type of securement, such as for example, welding or bolting, of tongue 26 onto the jacket unit 6 is conceivable.

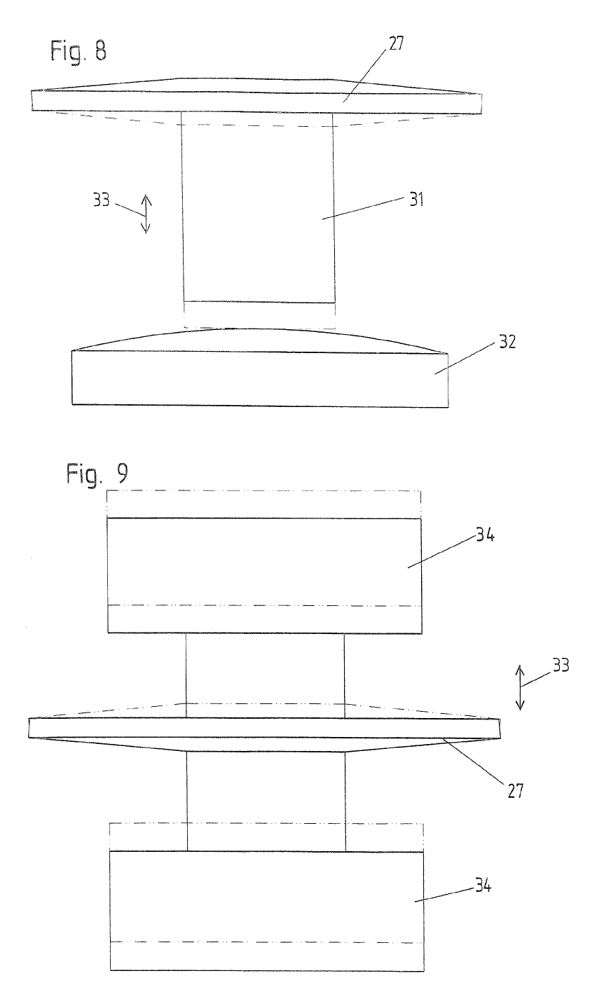

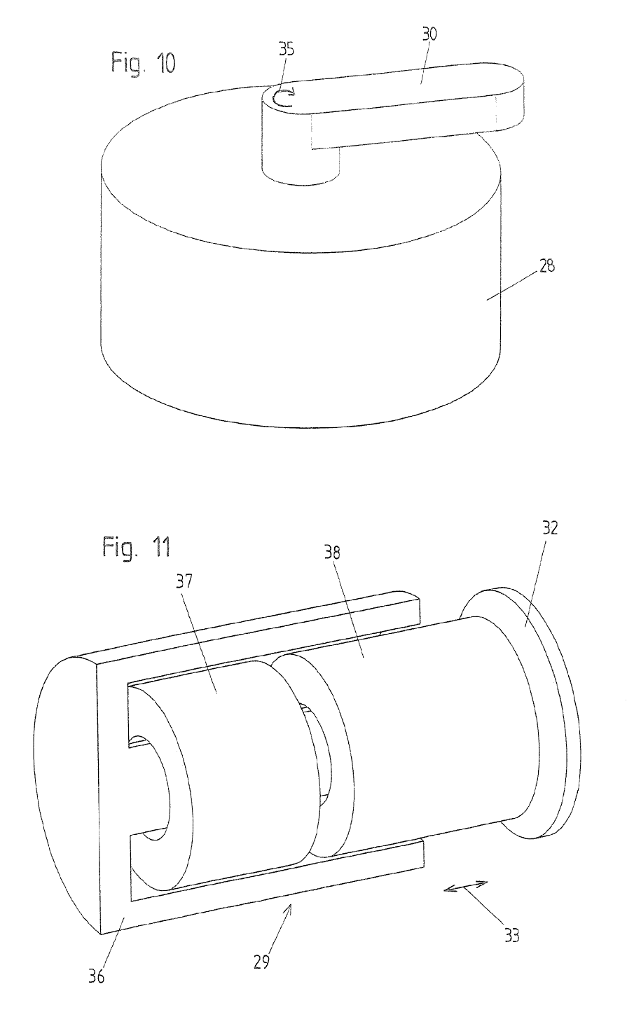

In the following, different types of generator devices 5 for a haptic signal will be explained by example. FIG. 8 shows a variant in which as the source a piezoelectric oscillator 27 is provided. Through the corresponding excitation, this oscillator sets the intermediate piece or the hammer 31 into single-stroke movement or vibration movements 33, whereby the hammer, in turn, strikes the anvil 32 via which the thus generated signal is conducted further. The hammer 31 can herein be secured in position on the piezoelectric oscillator 27. The solid line drawings and those shown as dashed line show, as does also the embodiment according to FIG. 9, the particular maximally deflected positions of the particular structural parts 27 and 31 or 34. FIG. 9 shows a variant of a generator device 5, in which on the piezoelectric oscillator 27 two counterweights 34 are disposed which, together with the piezoelectric oscillator 27, are set into vibrating movement 33 and thus amplify the signal. The transmission of the vibration onto a housing, not shown here, of the generator device 5, and therewith lastly onto the jacket unit 6, takes place via the suspension of the piezoelectric oscillator 27. FIG. 10 shows an example with a preferably electric motor 28. The motor generates a rotational movement 35 of the eccentric 30. Through its mass, or unbalanced mass the eccentric 30 generates herein a haptic signal which is transferred further via the motor 28 or its housing. FIG. 11 shows a magnetic coil arrangement for a generator device 5. On the pole plates 36 forming the magnetic core are seated a magnetizable core coil 37 and a magnetizable plunger coil 38. One of the coils is secured in position on the pole plates, the other is bearing supported such that it is movable in the direction of the vibration movement 33. Through the corresponding poling of the coils the movable coil is set into a single movement or into a vibrating movement 33, whereby correspondingly strokes are exerted onto the anvil 32 or it is set into vibration. The haptic signal is transferred further via the anvil 32. It is certainly also conceivable herein for one of the coils to be replaced by a permanent magnet.

In the depicted embodiments, the invention was illustrated in conjunction with a steering arrangement 1 for land-bound power-driven motor vehicles, such as for example passenger cars and trucks. It is understood that steering arrangements according to the invention can also be employed for powered two-wheelers such as motorcycles, mopeds and the like. However, the invention is not necessarily restricted only to steering arrangements for land-bound motor vehicles. It is in principle also feasible to employ corresponding steering arrangements, to mention only a few examples, also for airplanes, boats or ships.

### LEGEND TO THE REFERENCE NUMBERS

1 Steering arrangement
2 Motor vehicle
3 Steering wheel
4 Steering spindle
5 Generator device
6 Jacket unit
7 Console unit
8 Adjustment mechanism
9 Longitudinal direction
10 Vertical direction
11 Clamping mechanism
12 Manual operating lever
13 Connection bolt
14 Bearing
15 Regulation device
16 Grip part
17 Wheel
18 Combustion engine
19 Distance sensor
20 Position determination sensor
21 Signal line
22 Connection piece
23 Disc pack
23′ Disc pack
24 Securement hole
15 Hook
26 Tongue
27 Piezoelectric oscillator
28 Motor
29 Magnetic coil arrangement
30 Eccentric
31 Hammer
32 Anvil
33 Vibration movement
34 Counterweights
35 Rotational movement
36 Pole plates
37 Core coil
38 Plunger coil
39 Clamping plates

1-15. (canceled)

16. A steering arrangement for a motor vehicle, the steering arrangement comprising a rotatable steering handle, and a steering spindle, connected torsion-tight therewith, and at least one generator device for generating at least one haptic signal, wherein the steering spindle is bearing supported in a jacket unit of the steering arrangement, wherein the jacket unit is connected with the generator device for at least one haptic signal, and, as a transmission device for the transmission of the haptic signal to be generated by the generator device onto the steering spindle, is disposed between the generator device and the steering spindle;
wherein the jacket unit is securable on the motor vehicle via a console unit, the console unit comprising an adjustment mechanism with which the jacket unit is securable on the console unit in positions differing from one another, the adjustment mechanism including a clamping mechanism with which the jacket unit can be clamped securely on the console unit in positions differing from one another.

17. The steering arrangement as claimed in claim 16, wherein the generator device for the at least one haptic signal is disposed directly on the jacket unit.

18. The steering arrangement as claimed in claim 16, wherein the generator device for the at least one haptic signal is disposed on a tongue of the jacket unit.

19. The steering arrangement as claimed in claim 16, wherein the generator device for the at least one haptic signal, via at least one further structural part of the steering arrangement, is indirectly in connection with the jacket unit for the transmission of the haptic signal.

20-21. (canceled)

22. Steering arrangement as claimed in claim 16, wherein the adjustment mechanism is configured to allow an adjustment of the position of the jacket unit in a longitudinal direction of the steering spindle or in a vertical direction relative to an installation position of the steering arrangement in the motor vehicle or in a longitudinal direction of the steering spindle and in a vertical direction relative to an installation position of the steering arrangement in the motor vehicle.

23. (canceled)

24. The steering arrangement as claimed in claim 16, wherein the generator device for the at least one haptic signal is disposed on the adjustment mechanism.

25. The steering arrangement as claimed in claim 16, wherein the generator device for the at least one haptic signal is disposed on a manual operating lever or on a connection bolt.

26. The steering arrangement as claimed in claim 16, wherein the generator device for the at least one haptic signal is disposed on the console unit.

27. The steering arrangement as claimed in claim 16, wherein the jacket unit encompasses at least regionally a hollow volume in the form of a tunnel or tube and the steering spindle is guided through this hollow volume.

28. The steering arrangement as claimed in claim 16, wherein on or in the jacket unit at least one bearing is disposed, wherein the steering spindle is bearing supported in the jacket unit by the bearing.

29. The steering arrangement as claimed in claim 16, wherein the generator device for the at least one haptic signal comprises a vibrator for the generation of mechanical vibrations or pinging signals.

30. The steering arrangement as claimed in claim 16, wherein the jacket unit has a resonance frequency which agrees with a frequency of the haptic signal generatable by the generator device or is at least so close to the frequency of the haptic signal that the jacket unit can be set into resonance.

31. The steering arrangement as claimed in claim 16, wherein the rotatable steering handle is a steering wheel.

32. A method for operating the steering arrangement as claimed in claim 16, with the rotatable steering handle and the steering spindle connected torsion-tight therewith and the at least one generator device for generating at least one haptic signal, wherein the steering spindle is bearing supported in the jacket unit, said method comprising using the generator device to generate at least one haptic signal, and transmitting the haptic signal from the generator device via the jacket unit onto the steering spindle.

33. The method as claimed in claim 32, wherein the rotatable steering handle is a steering wheel.

34. (canceled)
